(19) United States
(12) Patent Application Publication
(10) Pub. No.: US 2013/0159329 A1
(43) Pub. Date: Jun. 20, 2013

(54) KNOWLEDGE MANAGEMENT SYSTEM

(71) Applicants: David I. Greenberg, Pacific Palisades, CA (US); Dov Seidman, New York, NY (US); Dwayne C. Jacobs, Newbury Park, CA (US); Jim Blackie, New York, NY (US); Mark Snyderman, Atlanta, GA (US); Melissa M. Allain, Castro Valley, CA (US); Richard Thompson, Parker, CO (US); Ron Charow, Summit, NJ (US)

(72) Inventors: David I. Greenberg, Pacific Palisades, CA (US); Dov Seidman, New York, NY (US); Dwayne C. Jacobs, Newbury Park, CA (US); Jim Blackie, New York, NY (US); Mark Snyderman, Atlanta, GA (US); Melissa M. Allain, Castro Valley, CA (US); Richard Thompson, Parker, CO (US); Ron Charow, Summit, NJ (US)

(73) Assignee: LRN CORPORATION, Los Angeles, CA (US)

(21) Appl. No.: 13/328,809

(22) Filed: Dec. 16, 2011

(51) Int. Cl. G06F 17/30

(52) U.S. Cl. 707/756; 707/E17.044

(57) ABSTRACT

The present design is a knowledge management system including a mapping engine configured to receive survey responses for a survey campaign completed by a survey participant and a set of mapping rules containing rules configured to map the survey responses to a set of knowledge resources specific to the activities, interactions and behaviors of a survey participant based upon the survey responses. The knowledge resources include information helpful to the survey participant to carry out a job related expected behavior or duty of the survey participant. The mapping engine is further configured to receive information about the activities and interactions of a survey participant, survey campaign, and knowledge resources that may be stored on a database, and transmit information about the set of knowledge resources to a designated entity, such as the survey participant or a system administrator.

### BACKGROUND OF THE INVENTION

1. Field of the Invention

The present invention relates generally to managing knowledge resources, and more specifically to efficiently managing and suggesting identification of business knowledge resources available from any of a variety of sources.

2. Description of the Related Art

Current businesses hire personnel having varying degrees of knowledge for the tasks they are expected to perform. For example, a person hired for the position of manager in a technology company may have knowledge of the technology generally and may have general management experience but may have limited knowledge regarding the operation of his or her employer. Alternately, a person having an engineering background and extensive knowledge of a company's products may be promoted to management, and such a person may know operations the technology involved extremely well but may have limited management experience. A person hired as a truck driver for the first time may need extensive information on how to perform his job.

Businesses faced with these situations typically provide an amount of training to the individual, but such training is costly and time consuming. Many employers provide initial manuals to new hires, but these manuals, as well as online resources, tend to seek to solve every possible issue or question any new hire may have, and some employees simply do not have the time to read them or find the information they need. As a result, newly hired personnel may have gaps in their understanding of the job duties and expectations.

As may be appreciated in these situations, a group of, for example, ten individuals having different backgrounds, qualifications, education, and experience hired for the same job will each likely have different needs. Providing a single knowledge resource or set of knowledge resources to all ten individuals will result in several persons receiving pages of information they do not need or do not understand. This wastes company time and resources.

Certain online knowledge resources can be made available to the person taking on a new position, but these online knowledge resources can suffer the same issue as employee manuals or training materials, i.e. more information is available/provided than is necessary.

It would therefore be beneficial to provide virtually any individual hired for virtually any job with educational resources specific to that individual and tailored for that job based on the individual employee's activities and interactions, without providing the individual with information that may be repetitive or completely unnecessary.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a general overview of operation of the present design;

FIG. 2 is a detailed depiction of components of the system;

FIG. 3 is a general operational flowchart; and

FIG. 4 shows a general operational flowchart of an alternate embodiment.

The exemplification set out herein illustrates particular embodiments, and such exemplification is not intended to be construed as limiting in any manner.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design provides a system for identifying and assessing activities and interactions of selected persons, either actual or anticipated, and providing such persons with either a list of appropriate available knowledge resources or the appropriate available knowledge resources themselves. The present design may be implemented in a computational environment and may enable the individual to access the system from a remote location, such as via the internet and/or using a device such as a smartphone.

The present design facilitates assessing the present activities and interactions as well as the background of an individual relative to the target position or anticipated tasks, using a series of queries established by the employer for the target position or anticipated tasks. The system then provides data to facilitate the evaluation of available knowledge resources for the target position or anticipated tasks. In addition, the system considers the information obtained regarding the individual and may provide a list of resources that would be appropriate for the individual's needs or duties relative to the target position. In this way, the person can simply answer a set of questions and can obtain the knowledge resources that are judged most effective for her to review.

While the present discussion mentions an employer, employee, and a target job, and is focused on providing knowledge materials and questions on behalf of employers, it is to be understood that the present design is not so limiting. By way of example, the present design may be employed in a variety of settings wherein resources are selected for individuals, such as government employees being hired, educational personnel being retrained, contractors bidding on projects, independent contractors being trained in IT repair, and so forth. In a broad sense, the present design is intended to solicit relevant information from targeted personnel and match knowledge to the individual in an efficient manner. The present disclosure is not intended to be limiting in this regard, but instead is intended to apply to any situation where a party or parties wish to match information or knowledge to specific individuals, generally referred to herein as “survey participant(s)”.

Also, as used herein, the terms “educational resource(s)” “resources” “educational information” “educational assets” “knowledge resources” and the like are used interchangeably and are intended broadly. Such terms when used herein may encompass virtually anything usable to educate an individual on any topic or concept, including but not limited to electronic information, videos, courses, books or other printed materials, and so forth.

The present design may therefore apply to an entity, such as an employer, seeking to provide a series of survey questions to employees or other personnel using a computing device or network. Based on answers to the questions provided by each survey participant, the present design compiles a listing of factors usable to provide each survey participant with knowledge resources appropriate for the survey participant's duties. Appropriate knowledge resources may include virtually anything that can educate an individual, such as materials or other educational assets (web-based and live education, papers, web sites, videos, seminars, etc.). The design may entail a survey participant entering data pertinent to his job functions into a survey, including diverse employment-related responses such as specific job functions or activities, geographic location, types of personnel the survey participant comes in contact with on a regular basis, governmental interface or oversight, leadership/management tasks, and so forth.

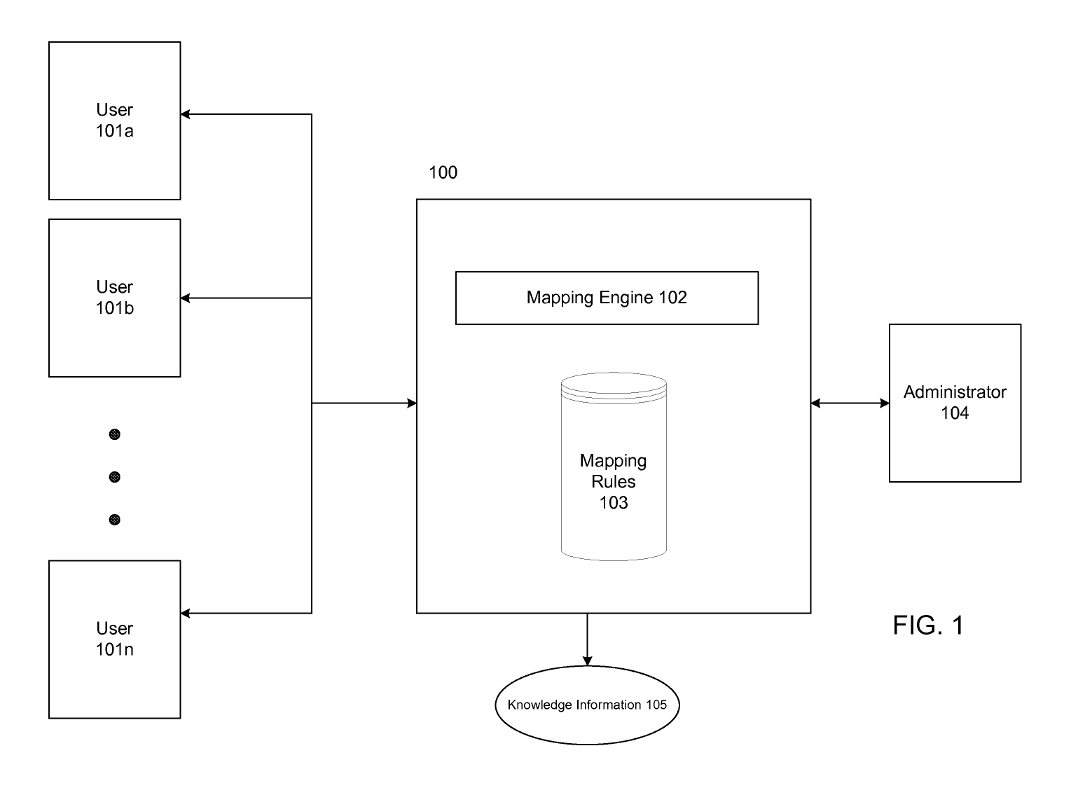

FIG. 1 illustrates a general conceptual depiction of the present design. Once the individual user has entered the requisite information, such information is submitted to a server or central computing device 100, which includes a mapping engine 102 with a set of mapping rules 103. The mapping engine 102 is configured to parse the received information from users 101a-101n, apply mapping rules 103 applicable to the answers provided, compile a prioritized set of what are called “knowledge categories” relevant to the organization and the user, and provide information to an administrator 104 or other relevant company personnel. The administrator 104 can choose the level of available information desired, including a detailed compilation of a user or respondent's answers to the survey, and a set of prioritized knowledge categories or a subset thereof. The administrator 104 may receive the set of prioritized knowledge categories or the subset thereof, and may collect and/or direct the user to the appropriate materials and/or information, shown as knowledge resource information 105. The administrator 104 may use the mapping engine 102 to collect other information, such as activities or information regarding or from third parties.

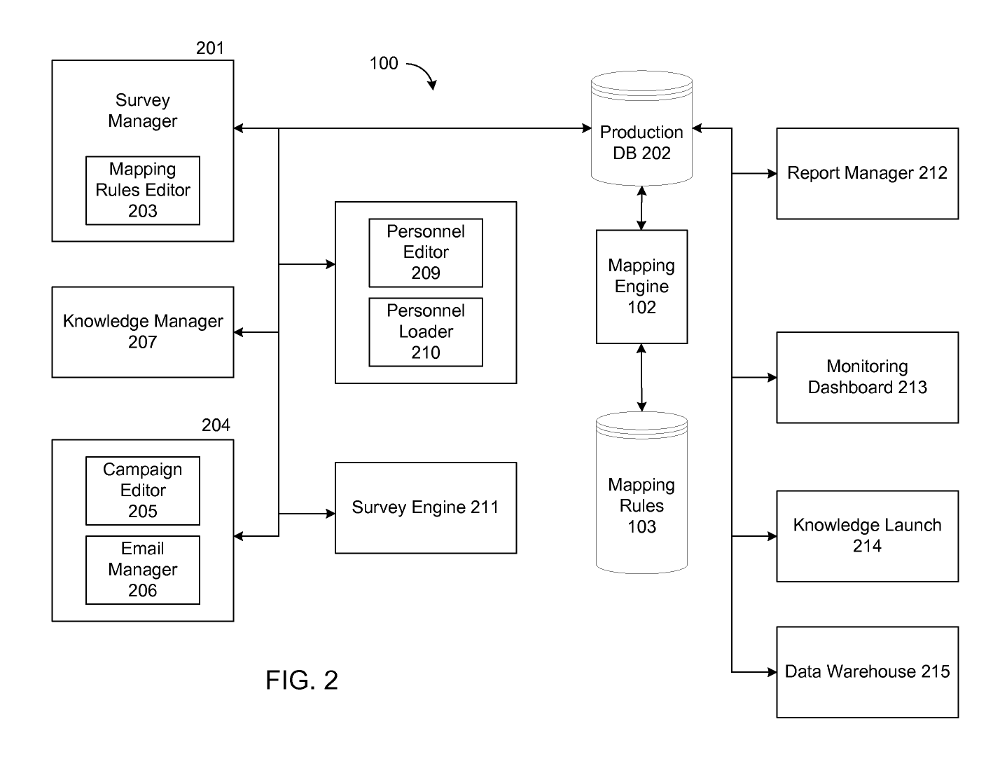

A second representation of the present design including various modules employed is provided in FIG. 2. From FIG. 2, a survey manager module 201 enables authorized personnel to create surveys, edit surveys, publish surveys, activate surveys, and delete surveys. The survey manager module 201 interfaces with the production database 202 and controls the survey. An authorized person may create a survey based on employer input, and that person or some other person may edit the survey to reword, include, or delete questions, and approved personnel may publish the survey, i.e. make the survey available for use. Surveys can be deactivated, either manually or automatically (such as by expiration of a time limit) and may be deleted altogether. The mapping rules editor 203 enables an authorized individual to create rules, edit rules, or delete rules, where rules generally map survey answers to resources. For example, if the individual answering a question in the survey indicates she has some antitrust responsibilities at the company and she has limited antitrust background, she would be directed to a general antitrust educational resource, such as an antitrust paper, presentation, web site, course, or other resource.

Campaign manager module 204 manages the campaign, representing a set of surveys to be administered. The set of surveys may include one or more surveys, and the campaign may include one or more people. For example, a training of all new department store clerks in a large department store chain may be a campaign intended to last for years. Campaign manager module 204 includes a campaign editor submodule 205 and an email manager submodule 206, where the campaign editor 205 enables authorized personnel to create a campaign, edit a campaign, delete a campaign, and schedule a campaign. The email manager module 206 works in conjunction with the campaign editor 205 to send a survey request to a specific entity and send a survey reminder to entities who are to participate in the campaign. Emails in this context can be to survey participants or principals, such as an email to request updating survey questions or other parts of the campaign.

Knowledge manager module 207 manages the knowledge resources. A set of resources may be made available initially and such a listing may be augmented, pared down, or otherwise altered using knowledge manager module 207. Knowledge in this context may be created by adding a resource to the set of resources, and knowledge may be edited or deleted. Thus the knowledge manager 207 enables authorized personnel to manage the resources by adding, deleting, or otherwise modifying the existing resources (books, papers, videos, web pages, etc.) or resource categories, also called knowledge categories.

Personnel manager module 208 manages the employees or personnel who are asked to complete surveys as part of a campaign. The personnel manager module 208 may include a personnel editor submodule 209 and a personnel loader module 210. The personnel loader module 210 simply bulk loads all relevant personnel into the database, where personnel information may include name, email address, position, and/or any other pertinent information. Personnel editor 209 enables authorized personnel to create an employee, edit an employee, and/or delete an employee, where employee is used here to generically refer to a survey participant. Survey engine 211 presents the survey, collects the response, stores interim responses, and submits final responses for mapping. Again, while employees are discussed, any entity may be the subject of this activity.

All of the modules interface with production database 202, and data from the campaigns, surveys, etc. are stored in production database 202. Mapping engine 102 employs mapping rules 103 to differentiate between the various pieces of information in production database 202. Mapping engine 102 administers the surveys and campaigns and allocates knowledge resources or suggests knowledge resources according to the rules in mapping rules 103, discussed below.

Data can be monitored via a report manager 212 or by a user interface, such as a monitoring dashboard 213 which can track the progress of campaigns, i.e. percentage completion, results, resources suggested, resources used, etc. Knowledge launch module 214 enables the survey participant to launch the knowledge selected for him, such as running videos or directing the user to web sites, or providing printed material as desired.

### Operation

Operation using the design of FIG. 2 may occur as follows. A system administrator may access the system, such as using a handheld device, computer, tablet, or other computing device. The system administrator connects to survey manager module 201, such as by clicking on a link on a website, and selects a survey. She reviews the Ethics and Compliance categories addressed by the system. The system administrator determines no risk exists in her organization around the Pharmaceutical or Food Handling areas, so she configures her survey to exclude those areas, removing the questions associated with them from the survey. She then adds some additional questions and mapping rules that her organization wishes to include in the survey process.

A system administrator may initially be provided with a list of questions for a particular topic area. Alternately, the system administrator may prepare all questions for a topic area of the survey. The system administrator may receive an initial blank survey and may be afforded an opportunity to select topics and add questions, or the system administrator may select topics or be provided with default questions. As may be appreciated, depending on the implementation and desires of administrators, a user may initially be provided with a pre-prepared set of questions, or may be presented with a web site or other selectable interface enabling selection of categories or questions for the survey, or may enter her own desired questions for the survey.

The survey may include default responses if desired. For example, a question having choices of “yes,” “no,” and “I don't know” may be populated with an “I don't know” response.

The goal of the categories, questions, and survey is to determine activities interactions and behaviors of the individual. This information may be used for many purposes within an organization, such as to enable an employer to provide the employee with a needed educational resource. Survey questions may cover a wide range, encompassing virtually any applicable topic. Questions may be broad but direct, such as “Do you work with ISO standards?” to narrow but indirect, such as “Do you interface with children in the work environment?” Questions may be tailored in different ways, but the goal of both the system, including in rules provided and data stored, as well as personnel such as system administrators, is to ask questions that elicit answers directed toward an educational resource or group of educational resources, with each question particularized to the business, activities and interactions of the individual, and/or anticipated responsibilities.

The system administrator may then contact knowledge manager module 207 and upload a list of knowledge assets that her organization wants to include in the knowledge mapping process relevant to the questions she added to the survey via the survey manager module 201. The list of knowledge assets may include, for example, a partner developed course on their industry, links to organization documents like the organization Code of Conduct and standard operating procedures (SOPs), as well as links to information on the organization intranet.

Once survey and knowledge information has been provided or identified, the system manager can survey organization employees. A system administrator may create a campaign for each site location, employees of one class (e.g. managers, truck drivers, pediatricians, teaching assistants). Using the campaign manager module 204, the system administrator may, for example, assign all employees at each physical site of a multinational corporation to a survey campaign for the site. Scheduling of campaign times may be variable and may be established by a system administrator, and survey manager 201 may request different start times and end times for campaigns for different sites, or may have all campaigns begin at the same time but end at different times, or whatever is desired.

The system may then contact each applicable employee, or survey participant, such as by email using the email manager submodule 206. A survey participant may work in the Sales and Marketing group and may receive an email informing her of the survey and/or campaign and may ask her to log in or otherwise contact the system. When the survey participant logs in, she may be directed to the survey she has been requested to complete, or she may be given instructions as to how to locate the survey herself. She may select a survey link which activates the survey engine module 211, presenting her with the organization survey launched by the system administrator. The employee may complete the survey or may partially respond to the survey and save her results, completing the survey at a later time.

When the survey participant submits the completed survey, the survey engine module may store and queue the answers to the survey for processing by the mapping engine 102. The mapping engine 102 may periodically or asynchronously process newly completed survey answers and may recommend knowledge assets appropriate for that employee based upon the mapping rules 103. An administrator may be afforded the opportunity to review, edit and approve the resource recommendations made by the mapping engine 102.

The survey participant may then log in and find the knowledge resources or assigned to her. Some may be grouped by category and others may refer directly to a specific link. The survey participant may select a course title and the knowledge launch module 214, which interfaces personnel with the knowledge assigned to them, may begin to run a suggested course or otherwise begin educating the survey participant.

Data relating to the campaigns may be collected at data warehouse 215. As an example, data from the survey, rules applied, courses or other knowledge resources recommended, courses or other knowledge resources obtained, courses or other knowledge resources completed, user satisfaction poll results, campaign completion percentages, and other related data may be stored in data warehouse 215. Using the data warehouse module, a system administrator can quickly manipulate and analyze data from multiple perspectives. Employee information may also be available from Human Resource interface systems (HRIS), and this information may be used by the system manager to determine effectiveness of campaigns, progress of campaigns, effectiveness of questions, or other measures. A system administrator may, for example, obtain or prepare reports on the knowledge areas identified as being needed by the organization as employees complete their surveys. At the end of each campaign, the system administrator can, for example, provide each site manager with reports showing what knowledge each survey participant of a certain group of survey participants or employees may need based upon answers to questions in addition to preferences, behaviors and interactions demonstrated by the survey results, separately or in combination with their personnel information. The system administrator may also provide a report sorted by area of need and who are the most “at risk,” generally defined as those who have skills or experiences least commensurate with their job duties. Such information can provide system administrators with an ability to prioritize who and what knowledge to assign first.

The result is a computer implemented system that is configured to execute a campaign and provide at least one survey to a user, the survey directed to ask a series of questions regarding the job activities performed and interactions experienced by the user. Once the survey is completed, the survey is provided to a centralized computing device or server that may store and may parse the received information, apply rules applicable to the answers provided, compile a set of prioritized knowledge categories applicable to the user, and provide the set of prioritized knowledge categories applicable to the user and his position to the administrator or other relevant company personnel. Company personnel can then rapidly and efficiently, or perhaps automatically, deploy the appropriate knowledge assets to the user or other personnel to reduce risks, develop relevant skills and allow the user or other worker to carry out employment duties more efficiently, in compliance with applicable laws, and consistent with the organization's values and policies.

### Operation of the Mapping Engine and Rules

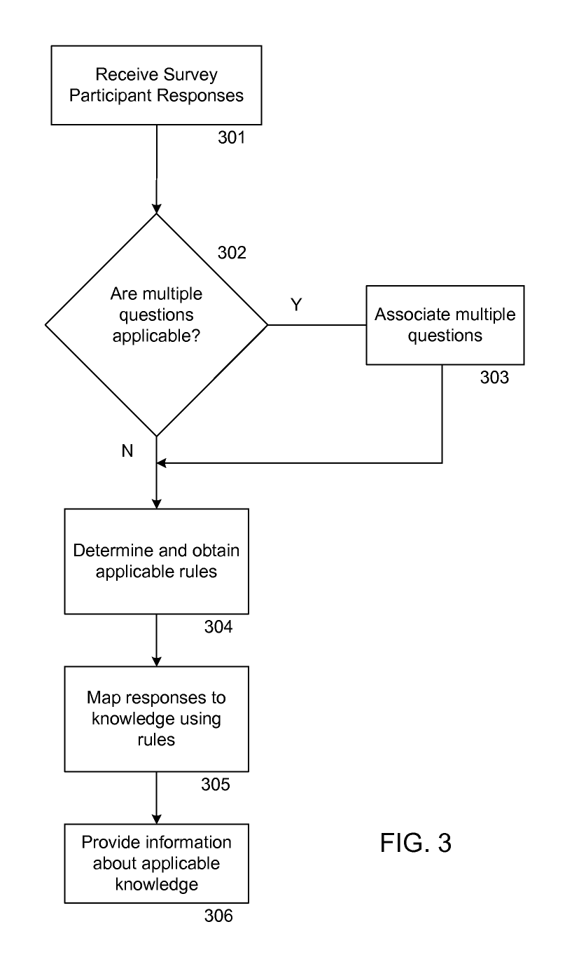

Mapping of survey question answers to knowledge resources can vary depending on the organization, questions, answers received, and resources. However, in general, operation of the mapping engine 102 and mapping rules 103, i.e. the primary components in server or central computing device 100 may occur as shown in FIG. 3.

From FIG. 3, mapping engine 103 may receive answers to questions for an employee who has participated in a survey at point 301. The answers may be yes or no answers, true/false, selection of one from a list, or may be user entered information. A selection mechanism may be presented such as a checkbox or set of checkboxes, a radio dial or numerical values, or any other input mechanism known in the art. A question number and a response is obtained, for example the answer to question 6 on survey 15432 for employee 64559 is “No.” At point 302, the system evaluates this answer and determines if any other question is applicable, i.e. if multiple answers are required to make a determination of at least one resource. For example, if a resource deals with land use regulations and is fairly advanced and not applicable for a new user, the questions asked may include “Have you dealt with land use regulations previously?” “If you have dealt with land use issues, how long have you dealt with such issues?” and “Are you currently familiar with the general land use laws for your city, county, and state?” Depending on the answers provided for these types of questions, the survey participant may be directed to the resource, or if he answers in a different way, he may be directed to other resources. Thus point 302 makes the determination whether other questions are applicable to specific questions asked, i.e. if there is an interrelationship between questions, and at point 303, the system determines the interrelationships between questions. Once interrelationship between one or more questions, or all questions, is established, point 304 consults with the rules and determines what question responses apply to what resources.

As may be appreciated, rules in this context may take many forms. For example, a rule may be simply if the answer to question 72(b) is “false” then the person should be directed to resource Y. There may be conditional rules, such as if the answer to question 8 is no and the answer to question 12 is more than 5, the user should be directed to resource B; if the answer to question 8 is no and the answer to question 12 is less than 5, the user should be directed to resource K; if the answer to question 8 is yes, the user should be directed to no specific resource.

The rules may or may not take into account incomplete or unanswered questions. Persons may, for example, simply not know the answer to a question.

There may be failure rules, such as if question X has not been answered, or if every single question has not been answered, the person should be directed to answer the question or questions and no recommendation will be made until the user has answered all questions. Alternately, if the campaign is ending and a user has answered only some questions, a report of the user's failure to complete the survey may be provided. Alternately, no resources may be recommended if one question has not been answered by a user. The mapping between a question or questions and a knowledge category or resource may be provided in a table, i.e. mapping rules 103 may be a table of mappings between questions and knowledge categories.

Rules may constantly be updated, as may questions and resources. For example, if a new resource becomes available applicable to a group of persons being surveyed, a question may be identified or created that would direct the survey participant to the resource as appropriate. If a person has completed his survey and has received a list of resources while a campaign is still ongoing, he may be directed to answer the specific question, or may be offered the option of reviewing the resource on some basis. If he has not completed the survey, the survey may be updated, the mapping between the question response and the resource provided to the mapping rules 103, and the campaign may proceed. Resources, mappings, and questions may be deleted or changed as desired, with commensurate changes made to the mapping rules 103, databases, and tables. Retired questions and/or mappings may be flagged for reporting purposes.

Should a survey participant complete a survey more than one time, such as rethinking his answers or seeking to find additional or different resources, the old mappings may be marked as “deleted” or similarly identified, and new mappings may be provided, including a new listing of resources. Additionally, a summary may be made available, such as a simple abbreviated list of resources and the survey participant's name or identifier.

Knowledge categories may also be provided rather than specific resources. For example, the survey participant may need to know more about Kansas state tax issues for construction equipment. Rather than providing a link or the actual tax code, the survey participant may be presented with a direction to “consult system administrator re: Kansas construction equipment tax codes” or simply identifying in some manner that the participant should obtain information in the knowledge area of Kansas construction equipment tax codes.

Notification in these instances may include sending emails or text message or voicemail messages as appropriate, such as via the email manager 206 in the campaign manager 204. Rules may be established for reminders, updates, and so forth.

Email manager 206 may include automated communications facilities for sending communications via a short messaging service text message, via wireless transmission such as a cellular network to a mobile phone. In a further arrangement, the process flow may involve sending a message to an email client that belongs to a designated team member, for example an Internet based webmail service, or Microsoft's Outlook and Outlook Express products.

Point 305 then maps the answers to the questions provided to individual resources. Once all resources have been identified based on all questions asked and answered, the system may provide a listing of resources either to an appropriate entity, such as the individual or to a system administrator, at point 306. The end product is thus a listing of resources possibly applicable to the participant being provided to an entity, such as an administrator or the survey participant, possibly including the resources or information about or links to the resources. In some situations, no resources, or perhaps a single resource, may be provided.

Information may be exported or possibly otherwise provided to the data warehouse module 215 while the process is ongoing, namely question answering, determining resources, and informing appropriate entities, such as survey participants or administrators, of resources. Thus the current state of a campaign or individual survey can be monitored and reported and any deficiencies or issues addressed.

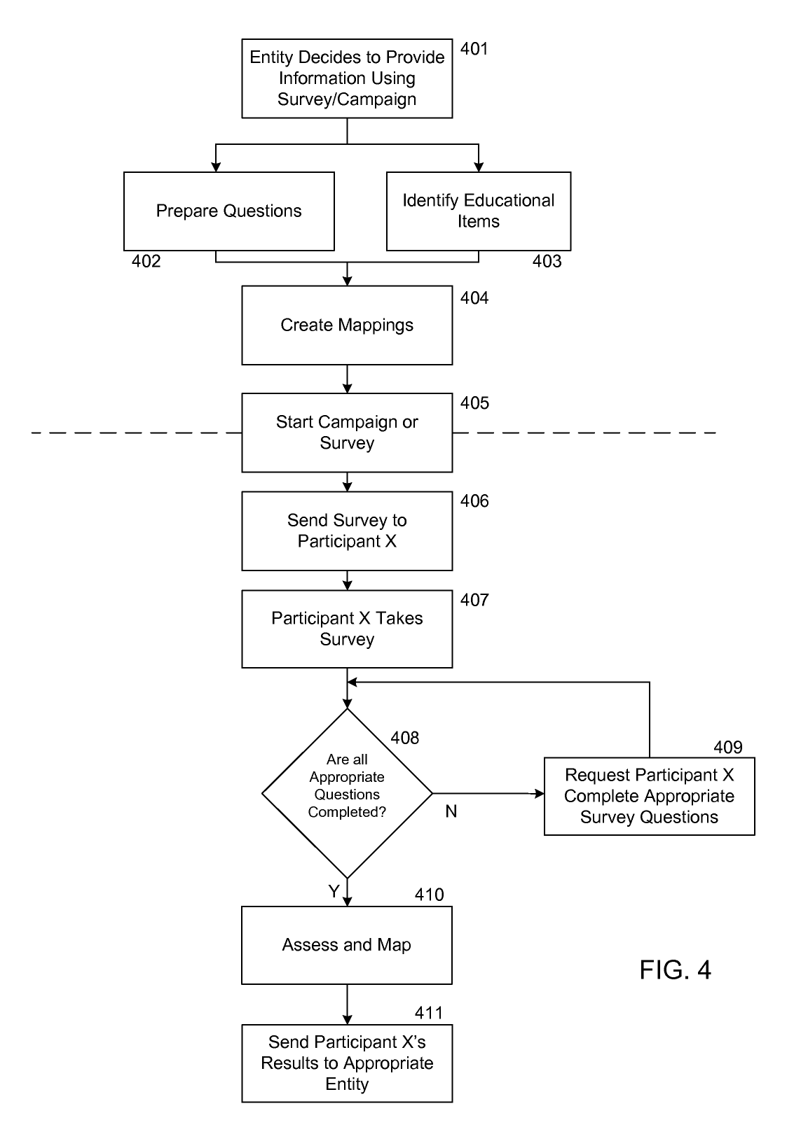

FIG. 4 illustrates an alternate view of general operation of the present design, but directed generally to the entire process. From FIG. 4, point 401 represents the decision of an entity to provide resources to users using a survey or campaign. Point 402 calls for preparation of questions and point 403 identifies resources, and points 402 and 403 may be done in parallel. Not shown in this view is the ability to revise questions and/or add resources, and point 402 may entail use of default or previously prepared questions. Point 404 creates a mapping as discussed herein, while point 405 represents the start of a campaign. Point 406 provides a survey to a survey participant, while point 407 calls for the survey participant to complete the survey. At point 408, the system evaluates completeness of the survey, and if not sufficiently complete, sends an indication to the survey participant to complete the survey. Point 409 represents assessing the question responses and mapping the responses to either knowledge categories or knowledge resources. Point 410 sends the results of the mapping to the survey participant, either personally or via a system administrator. Again, several aspects of the present design are not present in FIG. 4, such as reporting, evaluating campaign progress, establishing campaign dates, and other aspects that may, for example, be executed at any time or are optional.

The present design therefore is, in one embodiment, a knowledge management system including a mapping engine configured to receive survey responses for a survey campaign completed by a survey participant and a set of mapping rules containing rules configured to map the survey responses to a set of information specific to the survey participant based upon the survey responses. The knowledge resources include information helpful to the survey participant to carry out a duty anticipated to be required of the survey participant. The mapping engine is further configured to receive information about the survey participant, survey campaign, and knowledge resources stored on a database, and transmit information about the set of knowledge resources to a designated entity, such as the survey participant or a system administrator. The present design also includes a reporting module configured to report information about survey participants, campaign results, survey responses, and knowledge resources, a personnel manager module configured to create personnel information, for personnel who may be asked to participate in the survey, a knowledge manager module configured to create knowledge resource information, edit knowledge resource information, and delete knowledge resource information. Each of these modules provides information to the database.

The design also includes a survey manager module configured to create survey information, edit survey information, and delete survey information, and the database is configured to interface with a survey engine module configured to present the survey to the survey participant, collect survey responses from the survey participant, obtain interim responses, and present final responses to the mapping engine for mapping. The survey participant may be an employee, and the knowledge resources may comprise tangible educational information including educational documents and/or online resources.

An alternate embodiment of the present design is a method of providing knowledge resource information to a survey participant using a computing device. The method includes conducting a survey using the computing device, wherein the survey is provided to and responded to by the survey participant, receiving survey responses provided by the survey participant at the computing device, mapping the survey responses provided by the survey participant to a set of knowledge resources specific to the survey participant based upon the survey responses, the knowledge resources comprising information helpful to the survey participant to carry out a duty anticipated to be required of the survey participant and transmitting information about the set of knowledge resources to a designated entity.

The present design may be implemented using a network or distributed system, including a single server or multiple servers, and functionality may be distributed over multiple components or may exist in a single component. Further, functionality described herein may operate in hardware, software, firmware, or any combination thereof and no description provided herein is intended to be limiting in this regard. The present design may be substantially or completely internet based, operating with one or more servers, such that the user can access a server to request information, such as reports, as well as surveys, campaigns, resources, and other information. Users may modify the systems database contents from a platform providing, for example, Internet browsing capabilities.

While primarily described herein with respect to a knowledge management system, the invention and disclosure herein are not intended to be so limited. While certain examples are provided herein, these examples are meant to be illustrative and also not limiting as to the functionality of the present system. For example, while certain functions are suggested to be performed by a single individual, multiple persons may perform those functions. Other examples and implementations are possible and this document should not be limited by the examples presented. Other examples of knowledge resource allocation may be realized using the current design.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

1. A knowledge management system comprising:
a computing device comprising a processor with memory, the computing device further comprising:
a mapping engine configured to receive survey responses for a survey campaign completed by a survey participant;
a set of mapping rules containing rules configured to map the survey responses to knowledge resources specific to the survey participant based upon the survey responses wherein the knowledge resources comprise educational information; and
a database configured to maintain survey participant and survey campaign information;
wherein the mapping engine is further configured to receive survey participant and survey campaign information stored on the database, facilitate identification of a set of knowledge resources specific to the survey participant, and transmit information about the set of knowledge resources specific to the survey participant to a designated entity.

2. The knowledge management system of claim 1, further comprising a reporting module configured to report information about survey participants, campaign results, survey responses, and knowledge resources.

3. The knowledge management system of claim 1, wherein the database is configured to receive survey participant information from a personnel manager module configured to create personnel information, edit personnel participant information, and delete personnel information for personnel who may be asked to participate in the survey.

4. The knowledge management system of claim 1, wherein the database is configured to receive knowledge resource information from a knowledge manager module configured to create knowledge resource information, edit knowledge resource information, and delete knowledge resource information.

5. The knowledge management system of claim 1, wherein the database is configured to receive survey information from a survey manager module configured to create survey information, edit survey information, and delete survey information.

6. The knowledge management system of claim 1, wherein the database is configured to interface with a survey engine module configured to present the survey to the survey participant, collect survey responses from the survey participant, obtain interim responses, and present final responses to the mapping engine for mapping.

7. The knowledge management system of claim 1, wherein the survey participant is an employee.

8. The knowledge management system of claim 1, wherein knowledge resources can be identified, including educational information comprising at least one from a group consisting of educational documents, videos, courses, and online resources.

9. The knowledge management system of claim 1, wherein the designated entity comprises one from the group consisting of the survey participant and a system administrator.

10. The knowledge management system of claim 1, wherein the knowledge resources comprise information helpful to the survey participant to carry out a duty anticipated to be required of the survey participant.

11. A method of providing knowledge information to a survey participant using a computing device, comprising:
conducting a survey using the computing device, wherein the survey is provided to and responded to by the survey participant;
receiving survey responses provided by the survey participant at the computing device;
mapping the survey responses provided by the survey participant to a set of knowledge resources specific to the survey participant based upon the survey responses using the computing device, the knowledge resources comprising information helpful to the survey participant to carry out a duty anticipated to be required of the survey participant, wherein the knowledge resources comprise educational information; and
transmitting information about the set of knowledge resources to a designated entity.

12. The method of claim 11, further comprising reporting information about survey participants, campaign results, survey responses, and knowledge resources to an entity.

13. The method of claim 11, further comprising receiving survey participant information from a personnel manager module configured to create personnel information, edit personnel participant information, and delete personnel information for personnel who may be asked to participate in the survey.

14. The method of claim 11, further comprising receiving knowledge resource information from a knowledge manager module configured to create knowledge resource information, edit knowledge resource information, and delete knowledge resource information.

15. The method of claim 11, further comprising enabling an administrator to create survey information, edit survey information, and delete survey information.

16. The method of claim 11, further comprising presenting the survey to the survey participant, collecting survey responses from the survey participant, obtain interim responses, and presenting final responses to the mapping engine for mapping.

17. The method of claim 11, wherein the survey participant is an employee.

18. The method of claim 11, wherein knowledge resources identified include educational information comprising at least one from a group consisting of educational documents, videos, courses, and online resources.

19. The method of claim 11, wherein the designated entity comprises one from the group consisting of the survey participant and a system administrator.

20. A knowledge management system comprising:
a computing device comprising a processor with memory, the computing device further comprising:
a database configured to maintain survey participant and survey campaign information;
a mapping engine configured to receive survey responses for a survey campaign completed by a survey participant; and
a set of mapping rules containing rules configured to map the survey responses to knowledge resources specific to the survey participant based upon the survey responses, wherein the knowledge resources comprise information helpful to the survey participant to carry out a duty anticipated to be required of the survey participant, wherein the knowledge resources comprise educational information;
wherein the mapping engine is further configured to facilitate identification of a set of knowledge resources specific to the survey participant and transmit information about the set of knowledge resources specific to the survey participant to a designated entity.
